(19) United States
(12) Patent Application Publication
(10) Pub. No.: US 2007/0035237 A1
(43) Pub. Date: Feb. 15, 2007

(54) Pixel structure and organic electroluminescent panel having the same

(75) Inventors: Chung-Chun Lee, Yuan Lin Hsien (TW); Fan-Hsiu Chang, Miaoli County (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 11/491,138

(22) Filed: Jul. 24, 2006

(30) Foreign Application Priority Data
Aug. 12, 2005 (TW) 94127638

(51) Int. Cl. H01J 1/62; H01J 63/04

(52) U.S. Cl. 313/504

(57) ABSTRACT

A pixel structure for use in a white light emitting organic electroluminescent device therein comprises a first sub-pixel, a second sub-pixel, a third sub-pixel, and a fourth sub-pixel. The first sub-pixel has a first color filter and a first color change medium. The second sub-pixel has a second color filter and a second color change medium. The third sub-pixel has only a third color filter. The fourth sub-pixel does not have any color filter or color change medium so that the white light emitted from the white light emitting organic electroluminescent device can pass through the fourth sub-pixel directly. Thereby, the white light can be transformed into the color corresponding to each color change medium. Besides, the color shown from the pixel structure can be modulated by the white light from the fourth sub-pixel.

### BACKGROUND OF THE INVENTION

(1) Field of the Invention

The invention provides a pixel structure, especially related to the pixel structure used in an organic electroluminescent device.

(2) Description of the Prior Art

Referring to FIG. 1, a diagram of a pixel structure of a full color organic electroluminescent (EL) devices is shown.

The white color EL device 10 is disposed on a substrate 11. A red color filter 13, a green color filter 14, and a blue color filter 15 are disposed under another substrate 12 above the previous substrate 11. As FIG. 1 shows, the substrate 11 and the substrate 12 are sealed face to face (though not shown in the figure), wherein the light emitted from the top of the white organic EL device 10 passes through the three color filters 13-15 in order to get a predetermined mixed color that image needs.

In the aforesaid design, the white sub pixel area is left unfiltered. This design has the advantage of lower power consumption and current density, by compared to a three-color filtered white-emitting organic EL device that is frequently used with apparatuses having white backgrounds such as the typical personal digital assistant or computer display.

However, the device described above has a disadvantage that the luminous intensity of the emitted light would decrease after passing through the filters. Also, the luminous efficacy of the blue light and the red light are worse than that of the green light.

### SUMMARY OF THE INVENTION

It is an object of the present invention to provide a pixel structure, which may lower the power consumption and enhance the luminous utility rate.

In the present invention, the pixel structure for use in a white light emitting organic electroluminescent device therein comprises a first sub-pixel, a second sub-pixel, a third sub-pixel, and a fourth sub-pixel. The first sub-pixel has a first color filter and a first color change medium. The second sub-pixel has a second color filter and a second color change medium. The third sub-pixel has a third color filter. However, the fourth sub-pixel does not have any color filter or color change medium so as to have the white light emitted from the white light emitting organic electroluminescent device able to pass through the fourth sub-pixel directly. Thereby, the white light can be transformed into the color corresponding to each color change medium. Besides, the color shown from the pixel structure can be modulated by the white light from the fourth sub-pixel.

To sum up, the present invention provides a pixel structure that can enhance the luminous utility rate by pre-changing the white light into corresponding red and green lights, and also can provide a transparent sub-pixel to allow the white light to pass there through directly. Comparing to the related art with the same brightness, the power consumption of the present invention is only 30% of that of the related art.

### BRIEF DESCRIPTION OF THE DRAWINGS

The present invention will now be specified with reference to its preferred embodiment illustrated in the drawings, in which

FIG. 1 shows a pixel structure of a related art;

FIG. 2 shows a diagram of an embodiment of the present invention;

FIG. 3 shows a diagram of another embodiment of the present invention;

FIG. 4A shows perspective an embodiment of the organic EL device of the present invention;

FIG. 4B shows the cross-section diagram of the organic EL device in FIG. 4A;

FIG. 5 shows perspective another embodiment of the organic EL device of the present invention; and

FIG. 6 shows a further embodiment of the organic EL device of the present invention.

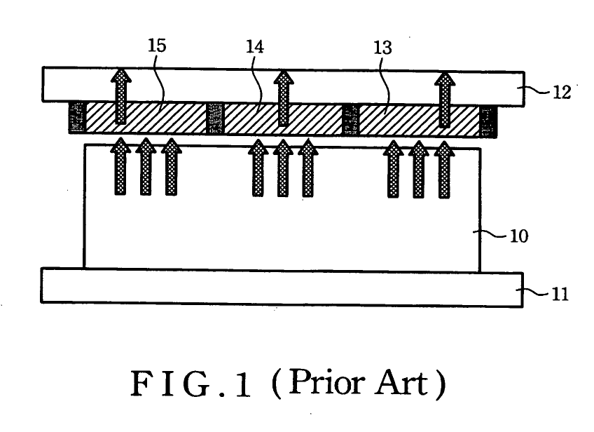

### DESCRIPTION OF THE PREFERRED EMBODIMENT

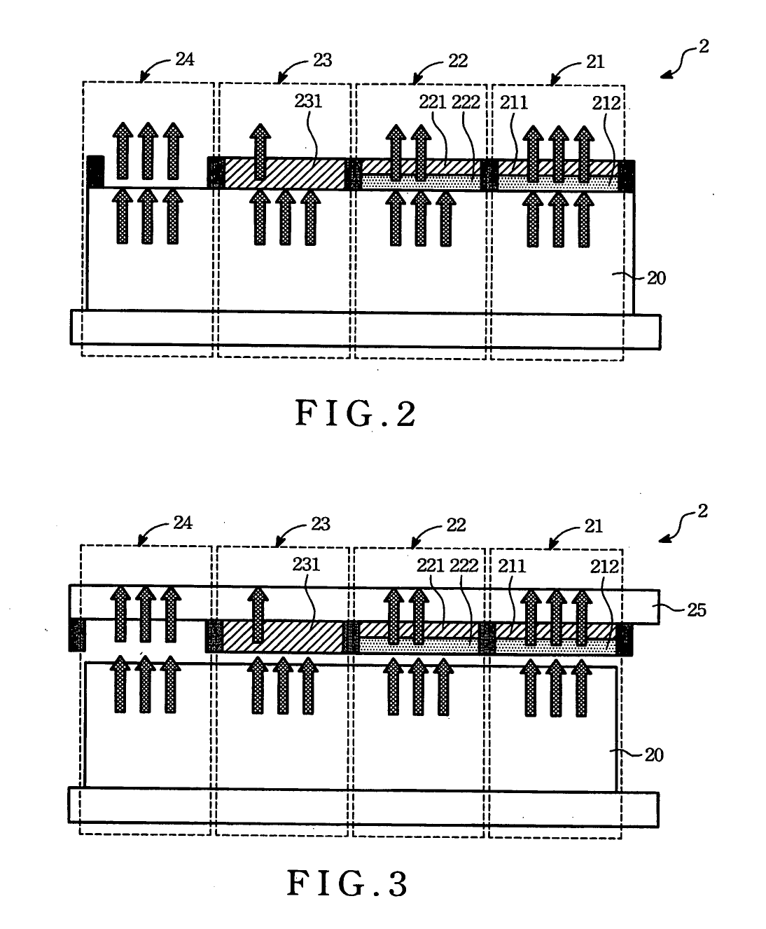

FIG. 2 shows one embodiment of the present invention, as a top-emitted pixel structure.

The light source of the pixel structure 2 is a white organic EL device 20, and the pixel structure 2 comprises a first sub-pixel 21, a second sub-pixel 22, a third sub-pixel 23, and a fourth sub-pixel 24. The first sub-pixel 21 includes a first color filter 211 and a first color change medium 212. The second sub-pixel 22 includes a second color filter 221 and a second color change medium 222. The third sub-pixel 23 includes a third color filter 231 but no change medium. The white organic EL device 20 emits white light passing through the first, second, third and fourth sub-pixels. The fourth sub-pixel 24 has neither the color filter nor the color change medium, and hence the white light can pass through the fourth sub-pixel 24 directly.

In the present embodiment, the first color filter 211 is a red color filter, and the first color change medium 212 is a red color change medium. The red color change medium can absorb the light with a particular wavelength of the white light emitted from the white organic EL device 20 (i.e., blue and green light) and further change these absorbed lights into a red light, and then the red light is released to pass through the red color filter 211. Thus, the utility rate of the emitted white light in red lighting is enhanced.

In the present embodiment, the second color filter 221 is a green color filter, and the second color change medium 222 is a green color change medium. The green color change medium can absorb the light with a particular wavelength of the white light emitted from the white organic EL device 20 (i.e., blue and red light) and further change these absorbed lights into a green light, and then the green light is released to pass through the green color filter 221. Thus, the utility rate of the emitted white light in green lighting is enhanced.

Also, the third color filter 231 of the present invention can be a blue color filter. Similarly, after the white light emitted from the white organic EL device 20 passes through the third filter 231, only the blue light can pass through.

In addition, for the fourth sub-pixel is absent of any color filter and color change medium, hence the white light from the white organic EL device 20 may pass through the fourth sub-pixel directly. The white light from the fourth sub-pixel 24 mixes with the RGB lights from the first sub-pixel, the second sub-pixel, and the third sub-pixel to form the display color of the pixel structure.

For instance, while in displaying a particular color, the brightness of red light contributed by the first sub-pixel 21 is R1, the brightness of green light contributed by the second sub-pixel 22 is G1, the brightness of blue light contributed by the third sub-pixel 23 is B1, and the brightness of white light from the fourth sub-pixel 24 is W1. For the existence of the white light from the fourth sub-pixel 24, so, by compared to the related art, the required brightness R1, B1, and G1 can be reduced and thus the goal in power saving of the first, second, and third sub-pixels 21-23 can be achieved.

In the present embodiment, the three color filters 211, 221, and 231 of the corresponding sub-pixels 21, 22, and 23 are disposed on the top surface of the white organic EL device 20. However, in other embodiments of the present invention, a protect layer (not shown in the figure) may be sandwiched between the three color filters 211, 221, 231 and the white organic EL device 20, and the first color change medium 212 can be disposed upon the first color filter 211 and the second color change medium 222 can be disposed upon the second color filter 221. The fourth sub-pixel 24 has neither color filter nor color change medium, hence the white light can pass through the fourth sub-pixel 24 without any filtering and color changing.

FIG. 3 shows another embodiment of the present invention, wherein the color filters 211, 221, and 231 and the color change mediums 212 and 222 are disposed on the bottom surface of a filter substrate 25, which is disposed on the light emitted potion of the white organic EL device 20.

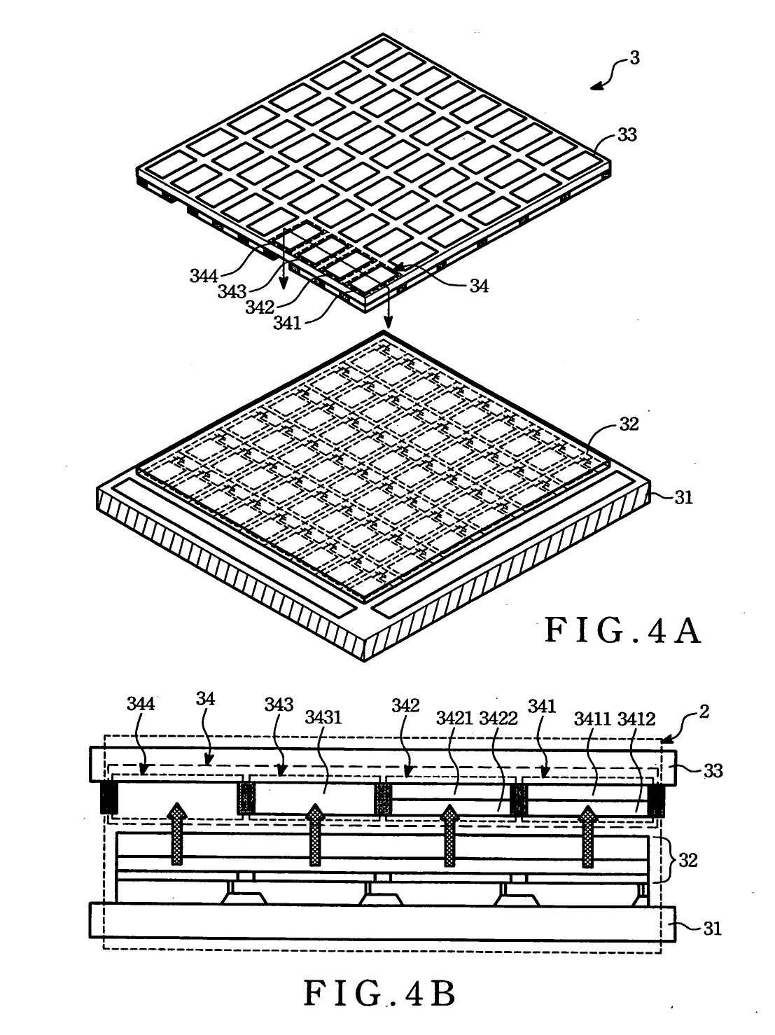

FIG. 4A and FIG. 4B show another embodiment of the present invention. An organic EL device 3 in FIG. 4A is a top-type emitting device driven by active matrix circuitry, wherein the pixel structure within the organic EL 3 is the same as the pixel structure in FIG. 3. FIG. 4B shows a typical the pixel structure of FIG. 4A.

The organic EL device 3 comprises an array substrate 31, a white organic EL device 32, and a filter substrate 33. The array substrate 31 is a glass substrate having a plurality of data lines and scan lines. The top surface of the glass substrate is divided into a plurality of array units, so formed as an array area. A plurality of transistors are disposed on every array unit individually to connect the data lines and the scan lines.

The white organic EL device 32 is composed of a first electrode layer on top, a second electrode layer at the bottom, and a middle emitting layer sandwiched in between. The white organic EL device 32 is disposed on the array substrate 31.

The second electrode layer described above is patterned on the array substrate and electrically connects to the transistors, the emitting layer (i.e., an electron transparent layer, an electric hole transparent layer, or a material layer) is formed upon the second electrode layer, and the first electrode layer is formed upon the emitting layer. Every transistor is used to control the power of the white organic EL device at the corresponding array unit.

The filter substrate 33 includes a plurality of filter areas 34 on the bottom surface facing the array substrate 31. One array unit, the white organic EL device and the filter area disposed to said array unit is called a pixel unit, like the pixel structure 2 we described in FIG. 3.

Every filter area 34 is composed of a first area 341, a second area 342, a third area 343, and a fourth area 344.

The first area 341 further includes a first color filter 3411 and a first color change medium 3412, wherein the first color filter 3411 is sandwiched between the first color change medium 3412 and the filter substrate 33.

The second area 342 further includes a second color filter 3421 and a second color change medium 3422, wherein the second color filter 3421 is sandwiched between the second color change medium 3422 and the filter substrate 33.

The second area 343 further includes a third color filter 3431 and no color change medium is present in the third area 343.

The white organic EL device 32 emits white light passing through the first, second, third and fourth areas. The fourth area 344 is transparent to the white organic EL device 32, and thus the white light may pass through the fourth area directly. Of course, a transparent flat layer could be disposed within the fourth area 344, but in this preferred embodiment of the present invention, there's nothing within the fourth area 344.

While the transistors power the electric current, the white organic EL device 32 emits white light. The emitted white light passing through the first area 341 and the second area 342 is changed to lights corresponding to different color filters; hence the luminous utility rate of the emitted white light can be increased. Meanwhile, the white light passing through the fourth area 344 can regulate the final color that the pixel structures 2 displays, and thus the goal of power saving can be achieved.

Though the embodiment described above is driven by the active matrix circuitry, however the driving mode of the present invention is not restricted. For example, a passive matrix circuitry can also work for the present invention.

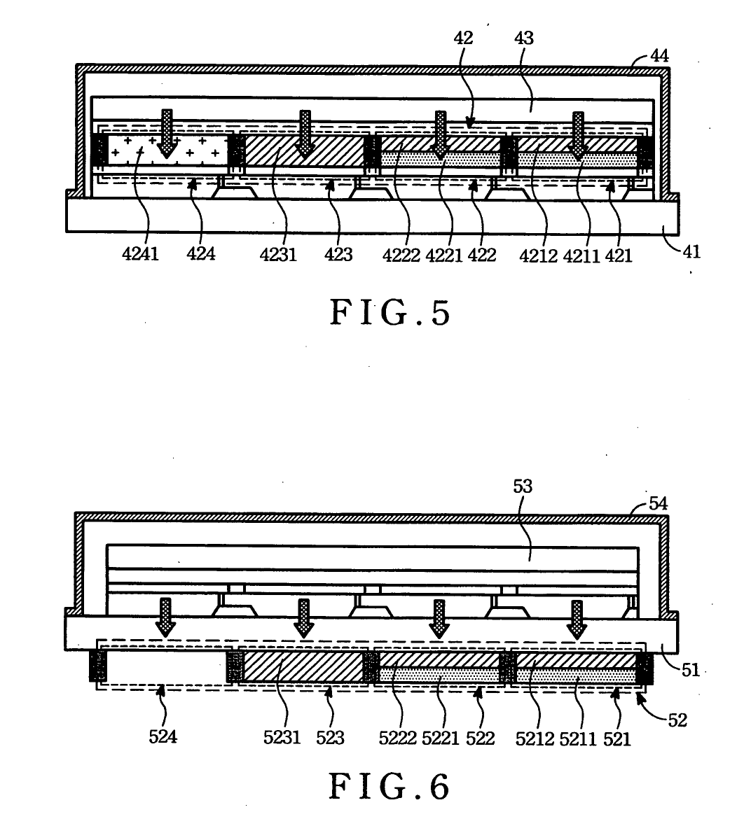

In addition, a bottom emission can also work for the present invention. FIG. 5 shows a cross-section diagram of another embodiment of the present invention, wherein a bottom emission is used in this embodiment. The white organic EL device of this embodiment is disposed on the filter areas, which is the same side with the array substrate.

The organic EL device in FIG. 5 comprises an array substrate 41, a plurality of filter areas 42, a white organic EL device 43, and a sealing top 44 which sealed with the array substrate 41.

A plurality of filter areas 42 are formed on the surface of the array substrate 41. Every filter area 42 is composed of a first area 421, a second area 422, a third area 423 and a fourth area 424. The light emitted from the white organic EL device 43 passes through the filter areas 42 as the arrows show.

The first area 421 further includes a first color filter 4211 and a first color change medium 4212. The second area 422 further includes a second color filter 4221 and a second color change medium 4222. The third area 423 further comprises a third color filter 4231, and the fourth area 424 further comprises a transparent flat layer 4241.

The transparent flat layer 4241 shall keep the same thickness with the whole filter areas 42 so as to evenly mount the white organic EL devices upon the filter areas 42.

FIG. 6 shows another embodiment of the present invention. The white organic EL device 53 herein is disposed on the opposite side of the array substrate 51 to the filter areas 52.

The organic EL device 5 comprises a array substrate 51, a plurality of filter areas 52, a white organic EL device 53, a sealing top 54 which sealed with the array substrate 51.

The white organic EL device 53 is disposed on one side surface of the array substrate 51, while the plurality of filter areas 52 is disposed on the other surface of the array substrate 51. Alike embodiments described above, every filter area 52 further comprises a first area having a first color filter 5211 and a first color change medium 5212, a second area 522 having a second color filter 5212 and a second color change medium 5222, a third area 523 having a third color filter 5231, and a transparent fourth area 521.

To sum up, the present invention provides a pixel structure that can not only enhance the luminous utility rate by pre-changing the white light into respective red and green lights, but can also provide a transparent sub-pixel to allow the white light to pass through directly. Comparing to the related art, on the basis of the same brightness, the power consumption of the present invention can be only 30% of the related art.

While the present invention has been particularly shown and described with reference to preferred embodiments thereof, it will be understood by those skilled in the art that various changes in form and detail may be made without departing from the spirit and scope of the present invention.

We claim:

1. A pixel structure for use in a white light organic electroluminescent device, comprising:
a first sub-pixel having a first color filter and a first color change medium;
a second sub-pixel having a second color filter and a second color change medium;
a third sub-pixel having a third color filter; and
a fourth sub-pixel, wherein the white light organic electroluminescent device emits white light passing through the first, second, third and fourth sub-pixels.

2. The pixel structure of claim 1, wherein the first color filter is a red light color filter, and the first color change medium is a red light color change medium.

3. The pixel structure of claim 1, wherein the second color filter is a green light color filter and the second color change medium is a green light color change medium.

4. The pixel structure of claim 1, wherein the third color filter is a blue color filter.

5. An organic electroluminescent device, comprising:
an array substrate;
a white light organic electroluminescent element disposed on the array substrate;
a filter substrate disposed upon the array substrate, one side of the filter substrate that faces the array substrate having a plurality filter areas, each of the filter areas comprising:
a first area having a first color filter and a first color change medium;
a second area having a second color filter and a second color change medium;
a third area having a third color filter; and
a fourth area, wherein the fourth area is transparent to the white light.

6. The organic electroluminescent device of claim 5, wherein the first color filter is sandwiched between the filter substrate and the first color change medium.

7. The organic electroluminescent device of claim 5, wherein the second color filter is sandwiched between the filter substrate and the second color change medium.

8. An organic electroluminescent device, comprising:
an array substrate;
a plurality filter areas formed on a surface of the array substrate, each of the filter areas comprising:
a first area having a first color filter and a first color change medium;
a second area having a second color filter and a second color change medium;
a third area having a third color filter; and
a fourth area having a transparent flat layer;
a white light organic electroluminescent element disposed upon the plurality of the filter areas, wherein the white light organic electroluminescent element emits light passing through the filter areas; and
a sealing top sealed with the array substrate.

9. The organic electroluminescent device of claim 8, wherein the first color filter is sandwiched between the array substrate and the first color change medium.

10. The organic electroluminescent device of claim 8, wherein the second color filter is sandwiched between the array substrate and the second color change medium.

11. An organic electroluminescent device, comprising:
an array substrate;
a white light organic electroluminescent element disposed on a surface of one side of the array substrate;
a plurality of filter areas formed on another side of the array substrate opposite to the white light organic electroluminescent element, each of the filter areas comprising:
a first area having a first color filter and a first color change medium,
a second area having a second color filter and a second color change medium,
a third area having a third color filter, and
a fourth area which is transparent for the white light to pass there through; and
a sealing top sealed with the array substrate.
